(19) United States
(12) Patent Application Publication
(10) Pub. No.: US 2020/0048503 A1
(43) Pub. Date: Feb. 13, 2020

(54) FUNCTIONAL FIBER REINFORCED ADHESIVE TAPE

(71) Applicant: SHURTAPE TECHNOLOGIES, LLC, Hickory, NC (US)

(72) Inventors: Windy Marie KATHAL, Hickory, NC (US); Peter Thomas ELAFROS, Hickory, NC (US); Khaled EL-TAHLAWY, Hickory, NC (US); Edward Stephen VARGAS, Hickory, NC (US)

(21) Appl. No.: 16/606,154

(22) PCT Filed: Apr. 27, 2018
(86) PCT No.: PCT/US2018/029829

§ 371 Date: Oct. 17, 2019

Related U.S. Application Data
(60) Provisional application No. 62/491,528, filed on Apr. 28, 2017.

(51) Int. Cl. C09J 7/29; B32B 5/02; B32B 5/06; B32B 27/12; B32B 27/32; B32B 37/15; B32B 38/00

(52) U.S. Cl. CPC C09J 7/29; B32B 2405/00; B32B 5/06; B32B 27/12; B32B 27/32; B32B 37/15; B32B 38/0004; C09J 2400/263; B32B 2255/02; B32B 2255/26; B32B 2262/0253; B32B 2262/0276; B32B 2305/188; B32B 2307/51; B32B 2323/04; B32B 2323/10; B32B 2367/00; B32B 5/024

(57) ABSTRACT

An adhesive tape includes a substrate layer, a carrier layer, and an adhesive layer. A plurality of functional fibers are stitch-bonded to at least one of the substrate layer and the carrier layer. The functional fibers may be parallel and may be in the machine direction or the transverse direction.

This application claims the benefit of U.S. Provisional Application No. 62/491,528 filed Apr. 28, 2017 and entitled “STITCH-BONDED ADHESIVE TAPE”, which is hereby incorporated by reference in its entirety.

### BACKGROUND

The present disclosure relates to an adhesive tape. Adhesive tape is a backing covered with a substance that binds or sticks to a surface (i.e., an adhesive). Duct tapes are generally considered a scrim inclusive pressure-sensitive tape.

Adhesive duct tapes are well known in the art. Duct tapes are widely used for purposes such as seaming metal ductwork, securing insulation, and other uses. A roll of pressure sensitive adhesive tape is often prepared by applying a pressure sensitive adhesive composition to a backing and then winding the backing on a cylindrical core to form the roll of tape. Generally, traditional duct tapes include a backing material, a bi-directional reinforcing scrim material, and a pressure-sensitive adhesive. While available duct tapes are considered a relatively strong class of adhesive tapes, certain applications could benefit from increased strength.

Accordingly, it would be desirable to identify a new adhesive tape with improved strength that is suitable for traditional duct tape environments.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

The present disclosure relates generally to fabric inclusive, e.g. functional fiber stitch-bonded fabric or a functional fiber warped knit fabric, adhesive tape.

According to one embodiment, an adhesive tape comprising a film having an outer surface and an inner surface is disclosed. The tape further includes an adhesive layer having an outer adhesive surface, an inner adhesive surface and a fabric layer comprising a plurality of fibers stitched or woven to a substrate. The fibers can be comprised of a higher strength material than the substrate material. The fabric layer is disposed between the outer surface of the film and the outer adhesive surface. The fabric layer is coated with a binder and/or melt adhered to the film.

According to a further embodiment, a method for forming an adhesive tape is provided. The method comprises stitch-bonding a plurality of fibers to a substrate layer to form a fabric. The fabric is disposed between an adhesive layer and a film to form a sheet. Binding of the fabric is performed using at least one of a melted region of the film, a melted region of the substrate layer of the fabric, the adhesive layer, or a binder. The fabric is secured to the film and the sheet is slit into strips of tape.

Accordingly to another embodiment, an adhesive tape including a polyolefin backing, a fabric layer comprising a fleece substrate and structural fibers in a warp orientation, and a pressure sensitive acrylic adhesive is provided. The fabric layer is melt bonded to the polyolefin backing. The fabric layer includes a polymeric coating. The structural fibers have a denier of between 500 and 5000. The tape has a shear strength of at least 80 minutes, a tensile strength of at least 80 lb./in., an elongation at break of at least 5%, and adhesion of at least 20 oz./in.

According to another embodiment, an adhesive tape is provided. The tape includes backing film having an outer surface and an inner surface. The tape further includes a pressure sensitive adhesive layer having an outer adhesive surface and an inner adhesive surface. The tape also includes a fabric layer comprising a plurality of fibers stitched or woven to a substrate. The fibers are comprised of a higher strength material than the substrate material. A laminating adhesive secures the fabric layer to the backing film. The fabric layer is disposed between the outer surface of the backing film and the outer adhesive surface. The pressure sensitive adhesive is at least one of comprised of a different polymer and/or has different properties than the laminating adhesive.

According to an additional embodiment, an adhesive tape is provided. The tape includes a backing film having an outer surface and an inner surface, the film being formed from a first polymeric material. The tape also includes a pressure sensitive adhesive layer having an outer adhesive surface and an inner adhesive surface and a fabric layer. The fabric layer includes a plurality of fibers stitched or woven to a substrate. The substrate is formed of a second polymeric material and the fibers are formed of a third polymeric material having a higher strength than the second polymeric material. The second polymeric material has a higher solid surface energy than the first polymeric material. The fabric layer is disposed between the outer surface of the backing film and the outer adhesive surface.

In a different embodiment, an adhesive tape is provided. The tape includes a polymeric backing film, a fabric layer comprised of a substrate and functional fiber stitched or woven to the substrate in a warp direction, and a pressure sensitive adhesive. The tape has a tensile strength greater than 700 lb./in. The adhesive can be rubber based with an adhesion strength of at least about 100 oz./in. The tape can further include a removable release liner (e.g. silicone coated paper).

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A is a cross-sectional view of an adhesive tape in accordance with certain embodiments of the present disclosure.

FIG. 1B is a cross-sectional view of an adhesive tape in accordance with certain embodiments of the present disclosure.

FIG. 2 is a cross-sectional view of another adhesive tape in accordance with certain embodiments of the present disclosure.

FIG. 3 is a top or bottom view of a stitch-bonded surface in accordance with certain embodiments of the present disclosure.

FIG. 4 is a flow chart illustrating a method in accordance with certain embodiments of the present disclosure.

FIG. 5 is a flow chart illustrating another method in accordance with certain embodiments of the present disclosure.

FIG. 6 includes a cross-sectional illustration of an adhesive tape in accordance with some embodiments of the present disclosure, a schematic illustration of a system for producing the tape, and a flow chart illustrating a method which may be used to produce the tape.

FIG. 7 includes a cross-sectional illustration of an adhesive tape in accordance with some embodiments of the present disclosure, a schematic illustration of a system for producing the tape, and a flow chart illustrating a method which may be used to produce the tape.

### DETAILED DESCRIPTION

The present disclosure may be understood more readily by reference to the following detailed description of desired embodiments included therein and the accompanying drawings. These figures are merely schematic representations based on convenience and the ease of demonstrating the existing art and/or the present development, and are, therefore, not intended to limit relative size and dimensions of the components thereof.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure is generally directed to a reinforced adhesive tape. The tape can include, at a minimum, a film backing layer, a reinforced fabric layer, and an adhesive layer. The reinforced fabric layer can include the combination of functional fibers and a substrate material. The substrate material can be sheet, woven and/or non-woven material.

Stitch bonding, knit strengthening, and warp knitting are viable options for formation of the fabric. The stitching or knitting fiber can have a structural feature that improves upon the characteristic of the substrate. In that regard, the fiber can be formed of a material different than the substrate. As one example, the material forming the fiber can have a higher strength than the material forming the substrate. Higher strength can be determined by using, for example, Thread Tensile Strength Test ASTM D2256 for each material.

The present disclosure contemplates the use of a warp knit fabric. Warp knitting is directed to knitting methods in which a yarn zigzags along the length of a fabric, i.e., following adjacent columns, or wales of knitting, rather than a single row. For comparison, knitting across the width of the fabric is called weft knitting. According to certain embodiments, a warp knit fabric can be made using an underlying base yarn to provide a skeletal support, and a functional yarn (e.g. high strength). The base yarn could be a full drawn polyethylene or polypropylene yarn. The functional yarn can be a polyester yarn. Both the base yarn and the functional yarn can be yarn made using pre-oriented yarn or partially oriented yarn that is warp spun at high speed. According to certain embodiments, the yarn can be a false twisted texture yarn, also known as a low stretch yarn. According to certain embodiments, the yarn is a full drawn yarn wound through melt spinning and stretching to achieve a highly oriented, medium crystalline filament.

According to certain embodiments, the weaving process can be performed by a high speed warp knit machine such as a Karl Mayer HKS-4 high speed knit machine. In at least some embodiments, the fabric substrate is a single layer mesh material with an open structure formed from nylon, polyester, nylon/polyester blends, polyethylene terephthalate, or other material. In certain embodiments, the mesh material has less than 50% open area (e.g., less than 50% of the material surface area comprises open space through which a viscous material can freely flow from one side to the other). Table 1 lists examples of the mesh material in at least some embodiments.

TABLE 2

| Material Type/Description | Example Commercially Available Product |
|---|---|
| 100% PET | E-minicell mesh 420D single mesh (Daewoo |
| | International Corporation, Pusan, Korea) |
| mesh | BULLHEAD mesh (Formosa Ting Sho Co., |
| | Ltd., Taiwan) |
| 35% rePET mesh | TENOR mesh (Joonang Textile Co., Ltd., |
| | Korea) |
| 38.6% rePET mesh | AIR TING mesh (Mogae Textile Co., Ltd., |
| | Busan, Korea) |
| 34% nylon 200D/84F, 66% | TLE8B001 DUONET (Tiong Liong |
| polyester 300D/168F | Industrial Co., Ltd., Taiwan) |
| 32% polyester 100D/36F, | TLD9B018 BLOCKBUSTER (Tiong Liong |
| 68% polyester 300D/168F | Industrial Co., Ltd., Taiwan) |
| 50% rePET mesh | MATRIX mesh (You Young Co., Ltd., |
| | Korea) |
| 30% rePET mesh | MONO RIB mesh (Dong Jin International |
| | Corporation, DaeGu, Korea) |
| 30% rePET mesh | thermoplastic mesh 6 (Duck San Co., Korea) |
| 30% rePET mesh | Egg mesh (You Young Co., Ltd., Korea) |

Stitch-bonded fabric is also contemplated for the subject adhesive tape. Stitch-bonding is a special form of warp knitting. Stitch-bonding involves layers of threads and fabric being joined together with a knitting thread, which creates a layered structure called multiply. This is created through a warp-knitting thread system which is fixed on the reverse side of the fabric with a sinker loop, and a weft thread layer. A needle with the warp thread passes through the material, which requires the warp and knitting threads to be moving both parallel and perpendicular to the vertical/warp direction of the stitch-bonding machine.

In one exemplary embodiment, one or more plies of a substrate material of fibrous nonwoven construction such as a spun-bonded fleece or is stitch bonded with a knitting yarn. By way of example only, the substrate material may be a spun-bonded polyester or polypropylene fleece having a mass per unit area of about 5 to about 30 grams per square meter. However, other materials with higher or lower weights may also be used.

During the stitch-bonding process a needle pierces the substrate material and engages stitching yarns delivered into position by a yarn guide such that the stitching yarns are captured within a hook portion of the needle. As the needle is reciprocated downwardly, a closing element such as a closing wire, which moves relative to the needle, closes the hook portion to hold the stitching yarns therein. With the hook portion closed, the captured stitching yarns are pulled through the interior of a preceding yarn loop disposed around the shank of the needle at a position below the substrate material. As the captured stitching yarns are pulled through the interior of the preceding yarn loop a stitch is formed which is knocked off of the needle. As the needle is raised back through the substrate material, the hook portion is reopened and a new yarn loop moves out of the hook portion and is held around the shank of the needle for acceptance of captured yarns and formation of a subsequent stitch during the next down stroke. As this process is repeated multiple times at multiple needles, a resultant stitch-bonded fabric is produced.

One challenge of using either stitch bonded or warp knit fabric to form an adhesive tape is the density of the fabric. Low porosity is problematic because it interferes with either melt bonding the fabric to the backing film and/or adhesive bonding. More particularly, a traditional duct tape scrim has a significant porosity (open spaces between fibers). For example, a scrim may have greater than 50% porosity. In contrast, the stitch bonded and warp knit fabrics of the present disclosure may have less than 50% porosity or less than 25% porosity or less than 10% porosity.

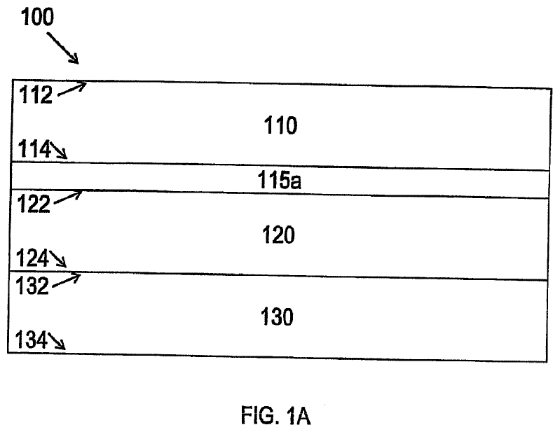

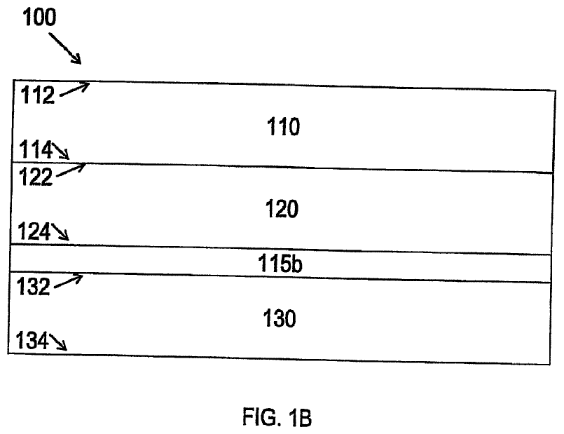

Turning now to several detailed embodiments, FIG. 1A is a cross-sectional view of an adhesive tape 100 in accordance with selected embodiments of the present disclosure. The tape 100 includes a substrate (e.g., film) layer 110 having a top surface 112 and a bottom surface 114, a carrier (e.g., nonwoven, foam, film, fleece, etc.) layer 120 having a top surface 122 and a bottom surface 124, an adhesive layer 130 having a top surface 132 and a bottom surface 134, and a functional fiber layer 115a between the substrate layer 110 and the carrier layer 120. The functional fiber layer 115a is stitch bonded to the bottom surface 114 of the substrate layer 110 or the top surface 122 of the carrier layer 120 or both of the substrate layer 110 and the carrier layer 120.

In one embodiment, the carrier-functional fiber component is a light weight (e.g., 8 ounces per square yard) spun bond, polypropylene fleece substrate with 1000 denier, for example, structural fibers at a rate of 17 per inch, for example. The structural fibers may provide very high tensile strength.

The stitch-bonding process can produce holes in the substrate. This could allow adhesive to bleed through the substrate which can make releasing/unwinding the tape difficult. To address this shortcoming, the top surface 112 of the film layer 110 may include a coating or additional film laminate to prevent such adhesive leakage. In a further alternative, it is contemplated that after stitch bonding to the film, the film can be treated (e.g. heat ionization) to create a reflow of polymeric material such that penetrating fibers are bonded to the film material.

Alternatively, an adhesive may be selected such that it quickly, after application to the sheet material, develops a viscosity that resists penetration through fiber holes in the film. For example, a natural rubber based adhesive could be employed.

FIG. 1B is a cross-sectional view of an adhesive tape 100 which is similar to that of FIG. 1A. The difference between these drawings is the location of the functional fiber layer. In FIG. 1B, the functional fiber layer 115b is located between the carrier layer 120 and the adhesive layer 130. The functional fiber layer 115b can be stitch bonded to the bottom surface 124 of the carrier layer 120. Alternatively, the functional fiber layer can be stitch bonded to the top surface 122 of carrier layer 120. In this configuration, the fiber layer 115b inclusive carrier layer 120 can be attached to the film layer 110 by an adhesive such as an acrylic/synthetic/natural rubber.

In certain alternative embodiments the fiber layer is attached to the film by extruding (e.g., melt extruding) the film layer onto a fiber layer. Alternatively, the carrier layer may be melted to effect attachment to the tape film backing layer.

Each of these configurations provide the further benefit of providing containment of the fibers. Moreover, the fiber layer inclusive carrier layer of the tape can develop an undesirable fuzz when the sheet material is cut to tape widths.

Optionally, one or both of the fiber layer and/or the carrier layer may be treated with a coating/binder such as a homo-polymer, copolymer or a terpolymer. The coating polymer can be any type of suitable synthetic/natural polymers or a natural polymer derivative. In certain embodiments one polymer component of a multi-polymer coating is provided to hold the fiber filaments together and one to improve bonding of the fibers to the adhesive and/or to the film. In the case of a terpolymer, one component can bind the fibers, one can aid bonding to the film, and another to the adhesive. The coating may be applied before or after the functional fiber is combined with the carrier layer. Moreover, the coating can be applied to individual fibers or to the completed (e.g. stitch-bonded) fabric. The coating can be applied by spraying or dipping, as examples. Exemplary synthetic polymers include vinyl acetate ethylene (EVA), styrene butadiene rubber (SBR), polyvinyl alcohol, and polyvinyl acetate. Natural polymers (e.g. gum, dextrin, starch, or cellulose) and derivatives (e.g. ethers, esters, grafted or crosslinked polymer) such as carboxymethyl cellulose, carboxymethyl starch, hydroxyethyl starch and starch graft copolymers are viable options.

The coating can further include an adhesion promoter such as polyethyleneimine, ionomers, anhydride-modified polyolefins, ethylene acrylic acid and silanes.

In certain embodiments, it is also envisioned that a diluted adhesive could be employed as the binder. For example, an acrylic adhesive diluted with at least 5% by weight toluene would adequately reduce fuzzing. In certain embodiments, the binder may further include an adhesion promoter such as polyethyleneimine.

A further alternative or addition to coating of the fabric is to utilize a relatively polar polymer or copolymer as the substrate material. Moreover, a high polarity polymer can aid in the bonding of the fabric layer to the backing layer and/or to the adhesive layer. Said in a related but alternate manner, using a polymer or copolymer to form the substrate which has a solid surface energy (SFE) higher than the backing material can be advantageous. Examples of suitable polymers can include polystyrene, polyvinylchloride, polymethylacrylate, polyethyleneoxide, polyethyleneterephthalate, polyetheretherketone, poly(ethylene-co-methyl acrylate), poly(ethylene-co-vinyl acetate), poly(ethylene-co-methyl-co-acrylic acid) and poly(ethylene-g-maleic anhydride).

### Examples

Numerous exemplary tapes were prepared using a polyethylene backing film hot melt extruded onto a fabric composed of polypropylene fleece having polyester functional fibers stitch bonded thereto in a warp direction. In various evaluations the fabric was either untreated, provided with a polymeric coating, or provided with a polymeric coating plus an adhesion promoter. An adhesive was applied to the fabric side of the backing/fabric component and numerous characteristics of the resultant tape were evaluated as shown in the following table.

| | | Low Tack Rubber | | | |
|---|---|---|---|---|---|
| | | No | | | High |
| | | Treatment | EVA | Adhesion | Tack |
| Properties | Units | on Fabric | Treated | Promoter | Rubber |
| Adhesion/Steel | oz/in | 66.4 | 51.3 | 69.4 | 117.2 |
| Adhesion/Backing | oz/in | 32.5 | 28.6 | 38.9 | 67.0 |
| 90 Degree QS | oz/in | 31.4 | 17.7 | 12.6 | 52.5 |
| Stretch | | 22.7 | 21.9 | 21 | 23.9 |
| Tensile | lb/in | 246.4 | 219.4 | 255.5 | 250.6 |
| Shear to Steel | min | 487.3 | 1917.3 | 1088.8 | 457.5 |
| Normal Unwind | lb/in | 1.8 | 0.9 | 0.8 | 4.5 |
| Cloth/Backing | oz/yd2 | 6.44 | 6.4 | 6.42 | 6.6 |
| Weight (oz/sqyd) | | | | | |
| Adhesive Weight | oz/yd2 | 5.72 | 6.44 | 6.4 | 6.6 |
| Tape Thickness | mils | 15.9 | 16 | 17 | 18.3 |
| Aged Rolling Ball | in | 2.3 | 3.2 | 2.3 | 0.9 |

In certain embodiments, the fabric can be laminated to a sheet material and melt bonded or adhesively laminated to the tape backing. Moreover, it may be advantageous to first adhere the fabric to a sheet material formed of a polymer material including polyolefin, polyvinyl chloride (PVC), ethylene vinyl acetate (EVA), or polyurethane (PU) and a laminating adhesive, such as, but not limited to, acrylic adhesive having a relatively high affinity for the fabric material and the tape backing. In certain embodiments, the laminating adhesive will be formed of a different compound and/or have different properties (such as adhesion value and/or viscosity) than the pressure sensitive adhesive layer (e.g. 130, 230) described below.

As will be noted by the skilled artisan, one component of the present disclosure is providing at least substantially straight and un-crimped structural fibers running in parallel and primarily in the warp direction of the tape. By providing only structural fiber in this orientation, i.e. eliminating the fabric substrate, the tape strength may be capable of achieving a theoretical maximum. Moreover, eliminating the substrate material allows a maximum presence of structural fibers. It is contemplated that a resin or polymer could be used to secure the structural fibers in a suitable orientation for melt bonding to the tape backing, wherein the resin/polymer will sublime at the temperature of the melt bonding procedure.

In certain embodiments, it is contemplated that the stitch-bonded fabric may be heated to a temperature above the melting point of the substrate material but below the melting point of the structural fibers. In this manner, the fabric layer can be self-contained to prevent fuzzing.

Where layers are illustrated adjacent to each other in the drawings, it should be understood that they may be in direct physical contact or one or more intermediate layers (not shown) may be included there between. For example, tie layers may be included to promote adhesion. Other optional layers can include foam, nonwoven pad, knitted or structural netting, film, metallized sheet, etc. that could impart structural characteristics, thermal, electrical, noise insulation, enhanced strength in length or width, etc.

In some embodiments, the carrier layer comprises polyester (e.g., polyethylene terephthalate (PET)) or polypropylene or polyethylene or cellulose or natural fibers (e.g., cotton, hemp, flax, etc). The carrier layer can be in the form of a non-woven such as fleece, foam, or a sheet. In some embodiments, the carrier layer can be a woven material comprised of a first fiber material. An example of a suitable material is a warp knit of denier greater than 1000 and at least 8×8, available from Milliken & Company. The carrier layer may have a thickness of from about 1 to about 15 mils, including from about 2 to about 10 mils. The structural fibers can be stitch bonded or warp knit to the carrier layer.

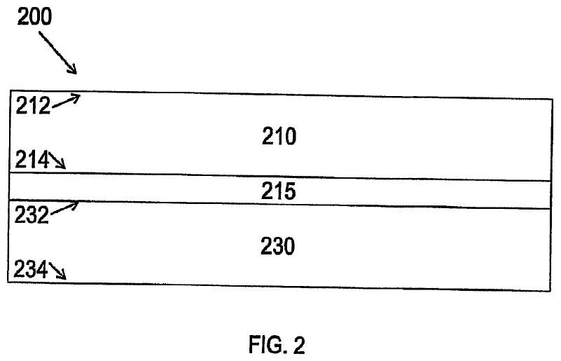

FIG. 2 is a cross-sectional view of another adhesive tape 200 in accord with some embodiments of the present disclosure. The tape 200 includes a substrate (e.g., film) layer 210 having a top surface 212 and a bottom surface 214, an adhesive layer 230 having a top surface 232 and a bottom surface 234, and a functional fiber layer 215 between the substrate layer 210 and the adhesive layer 230. The functional fiber layer 215 is stitch bonded to the bottom surface 214 of the substrate layer 210. Of course, the disclosure also contemplates a configuration where the functional fiber layer is attached to the substrate film layer 210 by melt bonding or adhesive.

The substrate layer 110, 210 may protect the carrier layer 120 (functional film layer 215) and adhesive layer 130, 230 from environmental conditions (e.g., water). In some embodiments, the substrate layer comprises polyethylene, polypropylene, polyvinyl chloride, and/or polyester. The substrate layer may have a thickness of from about 1 to about 20 mils, including from about 2 to about 15 mils. In some embodiments, the substrate layer has a thickness of from about 0.90 to about 1.45 g/cm³, including from about 0.91 to about 0.97 g/cm³, from about 0.90 to about 0.91 g/cm³, from about 1.1 to about 1.45 g/cm³, and from about 1.38 to about 1.39 g/cm³. The substrate layer may include one or more additives. In some embodiments, the additive(s) is/are selected from ethylene vinyl acetate, ethylene methyl acrylate, calcium carbonate, pigment, colorant, clay, and TiO₂. The substrate may be a monolayer or may comprise a plurality of sublayers.

In some embodiments, the adhesive layer 130, 230 comprises a pressure sensitive adhesive. The adhesive composition may be engineered for the structural characteristics of the substrate/stitched substrate. For example, it may be balanced to achieve a performance considering the interaction with the characteristics of the substrate (e.g., stiffness, bending strength, etc.). The adhesive can be one or more of a natural rubber, butyl rubber, acrylic rubber, synthetic rubber, butyl adhesive, and acrylic adhesive. In some embodiments, the adhesive layer is selected one or more of natural rubber, butyl rubber, acrylic rubber, synthetic rubber, a butyl adhesive material, and an acrylic adhesive material. The adhesive layer may have a thickness of from about 1 to about 15 mils, including from about 2 to about 10 mils.

The tape may have an overall thickness of from about 5 to about 40 mils, including from about 10 to about 25 mils.

The tensile strength of the adhesive tape may be greater than about 50 pounds per linear inch, greater than about 100 pounds per linear inch, greater than about 150 pounds per linear inch, greater than about 200 pounds per linear inch, greater than about 250 pounds per linear inch, and greater than about 300 pounds per linear inch.

In some embodiments, the tensile strength is from about 100 pounds per linear inch to about 500 pounds per linear inch. In some embodiments, the tensile strength is at least 200 pounds per linear inch, including at least 220 pounds per linear inch.

A suitable fiber denier for the functional fibers, can be determined by setting the desired strength based on the application, measuring the strength per denier, and calculating the denier needed to achieve the desired strength. In certain embodiments, the denier of the functional fibers will be different than the denier of the stitching fibers. For example, the functional fibers can have a smaller or larger denier. Similarly, it is envisioned that the material of the functional fibers can be different from the stitching fibers. Similarly, it is contemplated that different denier functional fibers are used across the width of the tape. For example, it may be advantageous to employ higher denier fibers adjacent the tape edges. In some embodiments, the denier is between 150 and 300. In some embodiments, the fibers are composes of many filaments. In some embodiments, the fibers are monofilament.

Accordingly, the strength of tape products produced according to some embodiments of the present disclosure may be easily tunable. The tape may have a full extension strength of at least 30 pounds, including at least 40 pounds, at least 50 pounds, at least 60 pounds, at least 70 pounds, and at least 80 pounds.

In some embodiments, the strength improvement is desired in the machine direction and there are no functional fibers in the transverse direction, thereby allowing the substrate to be stretched or pulled in the transverse/cross direction for conformability.

In some embodiments, the tape is hand-tearable in the machine direction between the functional fibers. This permits a customer to adjust the dimensions of each piece of tape. In some embodiments, the tape is pre-cut or perforated to tear in one of the cross or machine directions at predetermined lengths.

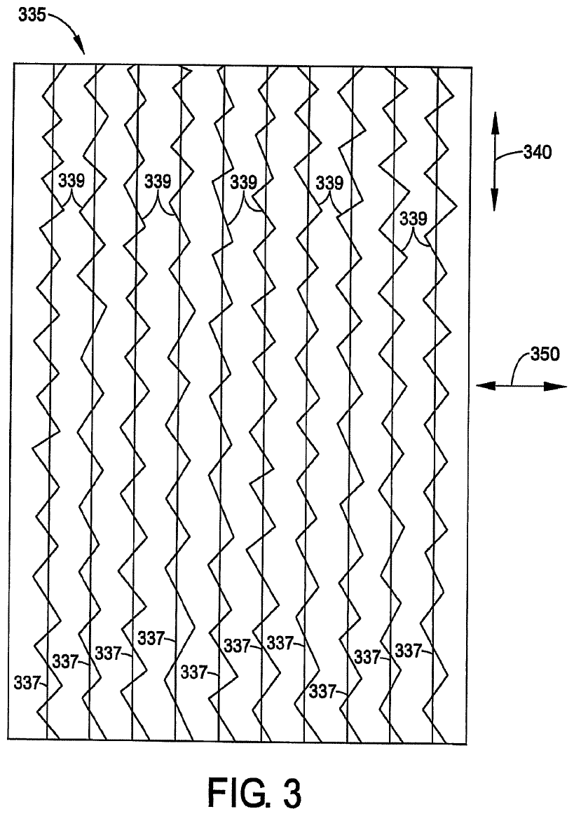

FIG. 3 is a top or bottom view of a stitch-bonded surface 335 in accordance with selected embodiments of the present disclosure. The arrows designate the machine (or long axis) direction 340 and the transverse or cross (or short axis) direction 350. A plurality of functional fibers 337 are secured to the surface via stitching fibers 339. The stitching fibers 339 generally cross over (back and forth) the functional fibers 337 to secure the functional fibers 337 to the surface. The surface 335 may represent one or more of the top surface 112, 212 of the substrate layer 110, 210; the bottom surface 114, 214 of the substrate layer 110, 210; the top surface 122 of the carrier layer 120; and the bottom surface 124 of the carrier layer 120 as illustrated in FIGS. 1 and 2.

The functional fibers and optionally the stitching fibers may be visible through one or both of the adhesive and/or the substrate layer. The substrate layer and the functional fibers can be of different colors. The substrate layer can be transparent and the functional fibers can be colored. The stitching fibers can be of a different color than the functional fibers. The stitching fibers can be visible on the top surface of the tape when it is applied to an object. The substrate and the stitching fibers can be contrasting colors of almost any combination.

The functional fibers may be visible through the adhesive and/or the substrate layer and provide some distinctive visual attribute. The stitching fibers may be visible through the adhesive and/or the substrate layer and provide some distinctive visual attribute. In some embodiments, the combination of functional fibers and stitching fibers provide a desired aesthetic appearance (e.g., a desired color scheme or a design indicative of the extreme functionality, strength, elasticity, and/or other properties of the tape). The stitching fibers may impart a surface character that will be discernible by touch. The functional fibers may impart a tactile feel running in the machine direction or other direction in which functional properties (e.g., strength) are desired.

In some embodiments, the functional fibers can be the stitching fibers. In embodiments wherein the functional fibers are stitched to the carrier layer, the carrier layer may impart a slight body to the tape.

In some embodiments, elastic (e.g., spandex) fibers can be enclosed in a sheath of other functional fibers (e.g., structural fibers). Once elongated, the sheath provides tensile strength at the fullest extension. In other embodiments, other functional fibers (e.g., structural fibers) can be enclosed in a sheath of elastic fibers.

The maximum elongation may be from about 20% to about 50%, including from about 25% to about 40%, and from about 30% to about 35%.

The functional fibers generally enhance one or more properties of the adhesive tape. Non-limiting examples of functional fibers include elastic fibers, strengthening fibers, and characteristic modifying fibers such as electrically conducting fibers. The functional fibers can be monofilament fibers or bundles of fibers (i.e., multiple strands). The elastic fibers can allow the tape to behave like a bungee cord, stretch and then recover strength. The strengthening fibers can impact tape strength. Conducting fiber can provide the tape with properties such as conductibility and/or conductivity.

In some embodiments, at least one of the functional fibers and the stitching fibers are monofilament fibers. The use of monofilament fibers may reduce or eliminate the “fuzzing effect” in comparison to multifilament fibers without reliance on the bonding techniques articulated previously. Fuzzing occurs when filaments extend from the sides of tape. This occurs, for example, when one large roll of material is cut into discrete rolls because the cutting blade may be on top of one of the fibers. Cutting the fiber can cause it to become loose on the side of the rolls, thereby making the tape look hairy. In the methods of the present disclosure, the cutting operation may be controlled to ensure that the blade does not cut through any of the functional fibers. For example, the slitting machine may be aligned with the large tape roll such that none of the blades intersect any functional fibers.

Non-limiting examples of functional fiber materials include polyester fibers, carbon fibers, and aramid fibers (e.g., para-aramid fibers (such as KEVLAR® from DuPont) and meta-aramid fibers (such as NOMEX® from DuPont)). Of course, in addition to the denier discussion above, the material selected for the functional fiber will influence the tape strength and elastic characteristics. In some embodiments, the fibers are coated to enhance chemical resistance, enhance flame resistance, increase/modify cohesion, increase/modify interlaminar bonding, and/or adjust other properties.

The fibers may be a combination of materials, with each fiber selected for its individual performance and its composite contribution to desired properties. Carbon fiber, electrical wire, elastic fiber, or other fibers may be stitched in location alone or in combination with other fibers. For example, every n^{th} fiber (e.g., 5^{th} fiber) could be an electrical wire or a sensor wired to detect temperature, pressure, etc. or to dissipate or conduct current.

The elastic fibers may have an elasticity of from about 25% to about 100% elongation. The elastic fibers may exhibit recovery with engineered extension and recovery force, dependent on the application. The elastic fibers may exhibit full extension tensile strength of from about 25 to about 200 pounds per linear inch. The fiber denier, diameter, and density can vary depending on the fiber material and desired performance characteristics.

The stitching fibers may include one or more materials selected from polyester, carbon and carbon compounds, specialty fibers including Kevlar, aramids, fiberglass, ultra-high-molecular-weight polyethylene (such as spectra and Dyneema), polyethylene, polypropylene, silk, spandex, rubber, vinyl, and nylon. To provide a desired strength, the stitching fibers can be oriented in a warp orientation of the tape strip.

In some embodiments, the fibers include structural sheathes, coatings, and/or windings to provide extension control and/or high tensile strength.

An engineered release composition or a release liner may be used in conjunction with the adhesive. The release composition may be applied to the top or back surface of the tape, allowing the adhesive to come in contact with the engineered fibers that are stitched through the substrate to allow a calibrated release allowing the tape to be unwound.

The engineered release system can be formulated in conjunction with the adhesive and one or both of the stitching fibers and/or the functional fibers. The release system can be applied to the top or back surface of the tape allowing the adhesive to come in contact with the engineered fibers that are stitched through the substrate to allow a calibrated release allowing the tape to the unwound, but balance the character of the unwind force, clean removal from the back of the tape & fibers, non-contamination of the adhesive, etc. The selected release composition can be selected to facilitate unwinding of a spooled adhesive tape. In this regard, the release composite can be selected to be interactive with the material(s) selected for the functional fiber(s). One exemplary release composition includes silicone and/or acrylic and/or chromium complex and/or fluorinated chemistries.

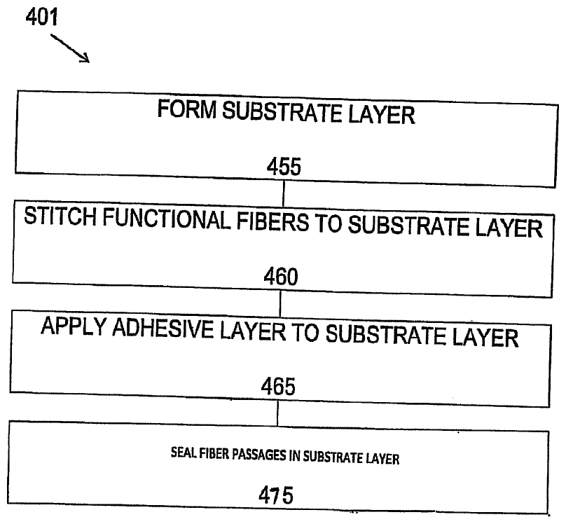

FIG. 4 is a flow chart illustrating a method for forming an adhesive tape 401 in accordance with some embodiments of the present disclosure. The method 401 includes forming a substrate (e.g., film) layer 455, stitching functional fibers to the substrate layer 460, and applying an adhesive layer to the substrate layer 465. The stitching step 460 may include feeding the substrate layer and functional fibers to a stitch-bonding machine, whereby the functional fibers are secured to a surface of the substrate layer via stitching fibers. In certain embodiments, the method will include a step 475 of sealing the fiber passages created in the substrate by, for example, heat treatment or application of a coating or further laminated film.

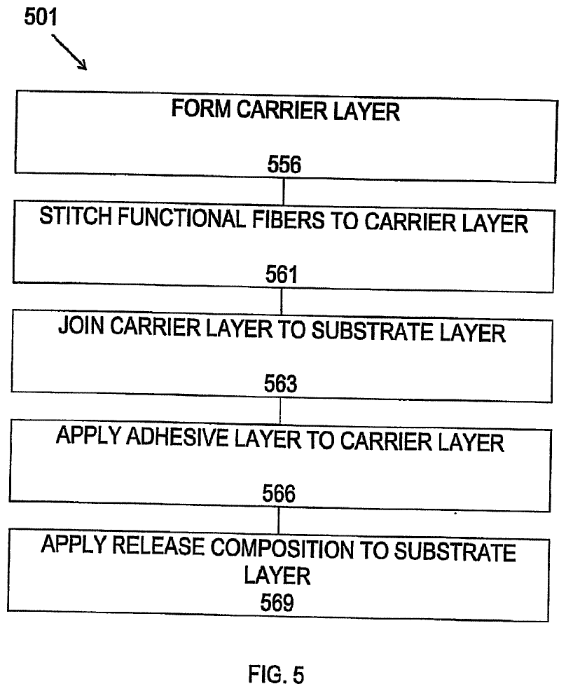

FIG. 5 is a flow chart illustrating another method for forming an adhesive tape 501 in accord with some embodiments of the present disclosure. The method 501 includes forming a carrier (e.g., nonwoven, fleece, etc.) layer 556, stitching functional fibers to the carrier layer 561, joining the carrier layer to a substrate (e.g., film) layer 563, applying an adhesive layer to the carrier layer 566, and applying a release composition to the substrate layer 563. The stitching 561 may include feeding the carrier layer and functional fibers to a stitch-bonding machine, whereby the functional fibers are secured to a surface of the carrier layer. In some embodiments, the joining the carrier layer to a substrate layer may include feeding the stitch-bonded carrier to calendaring equipment, whereby a substrate layer is melt extruded to the carrier. In some embodiments, the method may include a step of applying a release composition 569 to the substrate layer. Although not depicted, this step is also optional in the method of FIG. 4. In some embodiments, the method will further include binding of the carrier layer (with or without the functional fibers) with a coating to reduce fuzz. In some embodiments, the carrier layer including the functional fibers is embedded in the adhesive layer or the substrate layer to reduce fuzz.

It is noted that the tape can be constructed by formation of the described laminate in sheet form (e.g., 60″ wide sheet) which is then trimmed into tape width. The trimming step can be precise wherein the cutting element is prevented from wander to avoid cutting too many functional fibers.

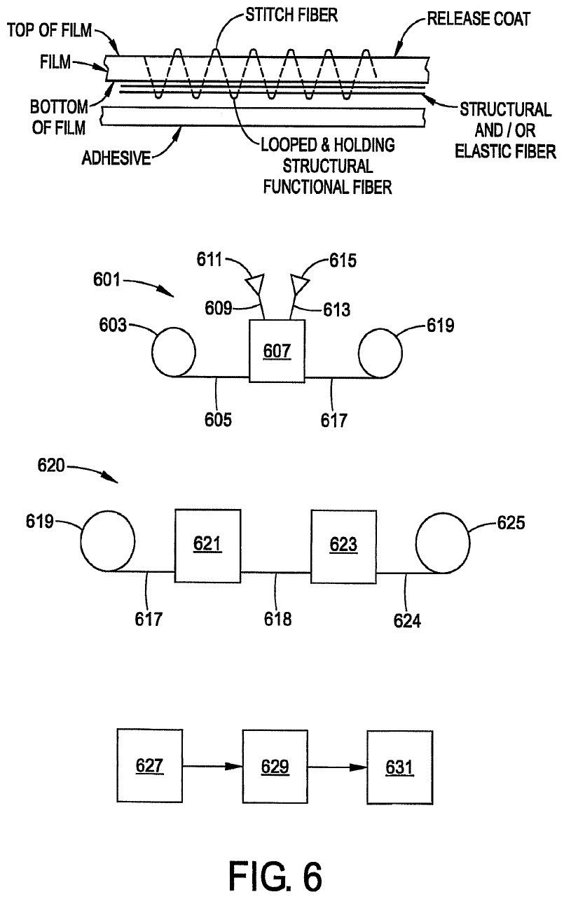

FIG. 6 includes a cross-sectional drawing of an adhesive tape in accordance with some embodiments of the present disclosure, a schematic illustration of a system for producing the tape, and a flow chart illustrating a method which may be used to product the tape. In the depicted embodiment, the fibers are stitched directly to the substrate (e.g., film). Particularly, in a first step 601 a film roll 603 provides a sheet of film material 605 to stitch bonding machine 607. Structural fibers 609 are provided from spool 611 to the stitch bonding machine 607. Stitching fibers 613 are provided from spool 615 to stitch bonding machine 607 wherein the structural fibers 609 are attached to the film sheet 605 to provide a reinforced tape backing sheet 617 which is wound onto roll 619 for further processing. Roll 619 is transported to a tape manufacture assembly step 620, wherein backing sheet 617 is fed to adhesive applicator 621 to form an adhesive inclusive sheet 618 and optionally a release coat applicator 623. The completed tape sheet material 624 is then rolled 625 and transported or stored for trimming in accord with traditional tape manufacturing processes. With respect to process flow, the tape backing is stitch bonded with functional fiber and rolled 627. The rolled tape backing then receives adhesive and optionally a release coat 629 and again rolled. The adhesive inclusive fiber reinforced tape sheet is then slit into appropriate tape widths, rolled, and packaged 631.

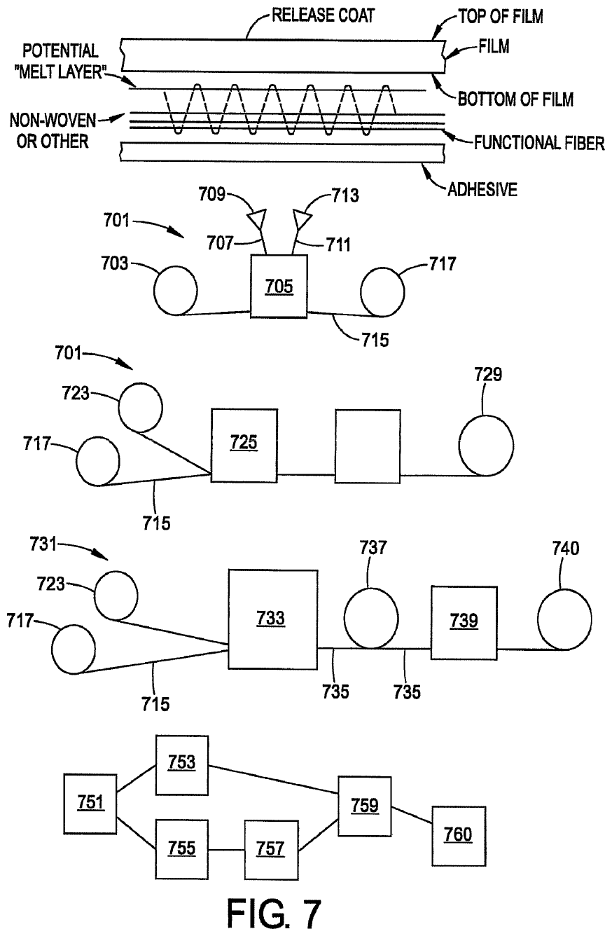

FIG. 7 includes a cross-sectional drawing of an adhesive tape in accord with some embodiments of the present disclosure, a schematic illustration of a system for producing the tape, and a flow chart illustrating a method which may be used to product the tape. In the depicted embodiments, the fibers are stitched to a carrier (e.g., nonwoven) prior to bonding to the substrate (e.g., film). In this embodiment, a first functional fiber inclusive fabric formation step 701 is provided. Particularly, a rolled substrate 703 (for example polyolefin sheet or fleece or non-woven) is fed to stitch bonding machine 705 wherein functional fiber 707 is received from spool 709 and stitch bonded to substrate 703 using stitching fiber 711 received from spool 713. The fabric 715 is then rolled 717 for further processing. In process step 721, fabric 715 is co-fed with tape backing substrate 723 into an adhesive applicator 725, release coat applicator 727 and then rolled 729 for further processing. At process step 731 and alternative tape formation procedure is depicted. In this configuration, fabric 715 is co-fed with tape backing substrate 723 into melt processor 733 wherein one or both of the fabric carrier and the tape backing substrate are melted and joined together to form reinforced tape sheet 735 which is rolled 737. Reinforced tape sheet 735 can then be fed to adhesive applicator 739 (application of a release coat is a further optional step—not shown) to obtain a finished tape sheet 740. With respect to process flow, a fiber reinforced fabric is formed 751, the fabric is joined with a tape backing using either adhesive 753 or melt adherence 755. If melt adherence 755 is used, adhesive is applied to the tape sheet 757. The adhesive inclusive tape sheet is then treated with a release coat 759 and again rolled. The adhesive inclusive fiber reinforced tape sheet is then slit into appropriate tape widths, rolled, and packaged 760.

In some embodiments, the tape adhesive layer is used to bond the fiber inclusive carrier layer to the tape backing. For example, co-extrusion of the fiber layer with a viscous adhesive layer can attach the fiber layer to the backing film substrate without puncture thereof. Moreover, a sufficiently low viscosity adhesive may adequately penetrate the low porosity fabric to achieve attachment to the tape backing layer.

The tapes of the present disclosure may offer enhanced properties for wrapping, holding, securing, sealing, bundling, pulling tight/taking slack out, closing, holding closed, holding tight, etc.

In some embodiments, the tape is a box-sealing tape, double-sided tape, duct tape, kinesiology tape, electrical tape, marking tape, friction tape, gaffer tape, masking tape, or surgical tape.

The composition, dimensional characteristics, mono filament versus engineered bundle, etc. can provide novel performance of the tape and the overall characteristics and/or type of suitable applications. Moreover, a wide range of fiber, denier and/or materials can be stitch bonded to the substrate. It can even be a combination of materials. In one version, a structural polyester fiber with each fiber selected for its individual performance and then its composition contribution to the tensile strength is selected. Individual fiber selection can be varied to give a physical characteristic to the tape, i.e. could be thick/large diameter or small to either be felt or seen as desired. Multiple layers could be stitch bond together in addition to the structural fibers. There could be a foam, nonwoven pad, knitted or structural netting, film, metallized sheet, etc. that could impact structural characteristics, thermal, electrical, noise insulation, enhanced strength in length or width, etc.

An exemplary tape construction includes a polyolefin backing, a carrier layer including structural fibers in a warp orientation, and a pressure sensitive adhesive. The warp fiber can have a tensile strength at least 80% greater than the carrier layer material. The warp fiber can have a denier of between 500 and 5000, and a spacing of between about 1 and 4 mm between adjacent fibers. The adhesive can be a pressure sensitive acrylic. The tape can demonstrate a shear strength of at least 80 minutes, a tensile strength of at least 80 lb./in., an elongation at break of at least 5%, and peel of at least 20 oz./in.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. An adhesive tape comprising:
a backing film comprised of polyolefin, polyvinyl chloride or polyurethane having an outer surface and an inner surface;
an adhesive layer having an outer adhesive surface and an inner adhesive surface; and
a fabric layer comprising a plurality of fibers stitched or woven to a substrate, said substrate being comprised of a woven or fleece material, said fibers being comprised of a higher strength material than the substrate material;
said fabric layer being disposed between the outer surface of the film and the outer adhesive surface, and wherein said fabric layer is coated with a copolymer or terpolymer binder.

2. The adhesive tape of claim 1, wherein the binder comprises a terpolymer.

3. The adhesive tape of claim 1, wherein the binder includes vinyl acetate ethylene, styrene butadiene rubber, polyvinyl alcohol, polyacrylate, gum, starch, dextrin, cellulose or a derivative thereof.

4. The adhesive tape of claim 1, wherein the binder further includes an adhesion promoter.

5. The adhesive tape of claim 1, wherein the binder comprises ethylene vinyl acetate.

6. The adhesive tape of claim 1, wherein the substrate is comprised of polyethylene, polypropylene, polyvinyl chloride, ethylene vinyl acetate, or polyurethane and the fibers are comprised of aramid, carbon, or polyester.

7. The adhesive tape of claim 1, wherein the substrate has a porosity of less than 25%.

8. The adhesive tape of claim 1, wherein the fibers have an elasticity of from about 5% to about 100% elongation and/or a full extension tensile strength greater than 80 pounds per linear inch.

9. The adhesive tape of claim 1, further comprising a release coating disposed on the outer surface of the film.

10. The adhesive tape of claim 1, wherein the adhesive layer comprises a pressure sensitive adhesive.

11. The adhesive tape of claim 1, wherein the fibers are comprised of monofilament.

12. (canceled)

13. (canceled)

14. (canceled)

15. A method for forming an adhesive tape comprising:
stitch-bonding a plurality of fibers to a substrate layer to form a fabric;
applying a polymeric binder to said fabric;
disposing said fabric between an adhesive layer and a film to form a sheet;
securing said fabric using a melted region of the film, or the adhesive layer; and cutting said sheet into strips of tape.

16. The method of claim 15 wherein the binder comprises, a copolymer or a terpolymer.

17. (canceled)

18. The method of claim 15 wherein said fibers are comprised of aramid, carbon or polyester.

19. The method of claim 15 wherein said fabric and said adhesive are co-extruded.

20. The method of claim 15 wherein cutting said sheet into strips of tape employs a cut disposed substantially between adjacent fibers.

21. (canceled)

22. (canceled)

23. An adhesive tape comprising:
a backing film having an outer surface and an inner surface, said backing film comprised of a first polymeric material;
a pressure sensitive adhesive layer having an outer adhesive surface and an inner adhesive surface; and
a fabric layer comprising a plurality of fibers stitched or woven to a substrate, said substrate material comprised of a second polymeric material, said fibers being comprised of a third polymeric material having a higher strength than the second polymeric material, and wherein said second polymeric material has a higher solid surface energy than the first polymeric material;
said fabric layer being disposed between the outer surface of the backing film and the outer adhesive surface.

24. (canceled)

25. (canceled)

26. (canceled)

27. The adhesive tape of claim 1, wherein the fibers are in a warp orientation and have a denier between about 500 and 5000, the tape having a shear strength of at least about 80 minutes, a tensile strength of at least about 80 lb./in., an elongation at break of at least about 5%, and an adhesion strength of at least about 20 oz./in.
